(19) United States
(12) Patent Application Publication
(10) Pub. No.: US 2026/0169872 A1
(43) Pub. Date: Jun. 18, 2026

(54) DISASTER RECOVERY ORCHESTRATION AS CODE FRAMEWORK

(71) Applicants: Shrujan Jyotindrabhai Mistry, Harrisburg, NC (US); Renoi Thomas, Thornwood, NY (US)

(72) Inventors: Shrujan Jyotindrabhai Mistry, Harrisburg, NC (US); Renoi Thomas, Thornwood, NY (US)

(21) Appl. No.: 18/983,500

(22) Filed: Dec. 17, 2024

(51) Int. Cl. G06F 11/14

(52) U.S. Cl. CPC G06F 11/2023

(57) ABSTRACT

According to some embodiments, systems and methods are provided including receiving a disaster recovery trigger, including an application identifier; retrieving the one or more tasks from a disaster recovery file including the application identifier, wherein the disaster recovery file is a YAML file; validating at least the retrieved one or more tasks and inputs; and migrating the application components including the application identifier from the primary region to the secondary region in response to execution of the validated one or more tasks. Numerous other aspects are provided.

### BACKGROUND

Technology plays an increasingly important role in every aspect of an enterprise, with applications and services enabling enterprises to be more agile, available and connected. A system breakdown or unplanned downtime can have serious consequences for the enterprises that rely heavily on these resources, applications, documents and data storage to keep things running smoothly. Disaster Recovery (DR) is an enterprise's method (e.g., policies, tools and processes) to regain or continue operations of information technology (IT) infrastructure, software and systems after events like a natural disaster (e.g., earthquake, flood, etc.), human-made disaster (e.g., cyber-attack), pandemics, technical hazards (e.g., power outages, etc.), machine and hardware failure or any other type of enterprise disruption. A disaster is any event that disrupts or completely stops an enterprise from operating. A variety of DR methods may be part of a DR plan. Without a DR plan, an enterprise may suffer data loss, reduced productivity, out-of-budget expenses, and reputational damage that can lead to lost clients and revenue.

Typically, DR involves securely replicating and backing up critical data and workloads to a secondary location or multiple locations—disaster recovery sites. Some enterprises may use a multi-region strategy for DR. With a multi-region strategy, workloads operate in a primary region and a secondary region with full capacity. The main data flows through the primary region and the secondary region acts as a recovery region in case of a disaster. In case of a disaster, the data flow through the primary region is migrated to the secondary region.

The DR process is initiated based on certain metrics like status checks, error rates, testing, etc. If the established thresholds are reached for these metrics, it signifies the data flow (e.g., workloads) in the primary region are failing. Switching the workloads from the primary region to the secondary region requires execution of certain steps (e.g., transferring data flow of a database component) in a particular sequence. While the execution of steps themselves may be automated, the initiation of the execution of the steps is a manual process. For example, a user may manually trigger an automation (e.g., code/application) to move the data flow of the database component from the primary region to the secondary region, and then manually trigger an automation to move data flow of an API gateway component from the primary region to the secondary region. This manual triggering of each automation is time consuming, as based on the number of steps/automations, it may take hours to trigger each automation (e.g., a dependent automation cannot be triggered until the automation from which it depends is complete), which may impact application recovery time objectives (RTO). RTO refers to the maximum amount of time it's acceptable to take to restore a network or application after a disruption. The goal of disaster recovery plans is to minimize RTO. Additionally, the manual triggering of each automation may be prone to error as the incorrect automations may be triggered and/or the correct automations may be triggered in the wrong order, etc.

It would therefore be desirable to provide improved systems and methods to orchestrate disaster recovery automations. Moreover, results should be easy to access, understand, interpret, update, etc.

### SUMMARY OF THE INVENTION

According to some embodiments, systems and methods are provided to accurately and/or automatically orchestrate the migration of data flow between multiple regions in response to a disaster (per a test, or live) in a way that provides fast and useful results and that allows for flexibility and effectiveness when implementing those results.

Some embodiments are directed to a disaster recovery system implemented via a back-end application computer server. The system comprises an application component data store that contains electronic records, each electronic record representing an application component, and including, for each application component, a component identifier, an application, a primary region and a secondary region; a disaster recovery file data store that contains electronic records, each electronic record representing a disaster recovery file, and including, one or more disaster recovery tasks for each application; the back-end application computer server, coupled to the data store, including: a computer processor; and a computer memory, coupled to the computer processor, storing instructions that, when executed by the computer processor, cause the back-end application computer server to: receive a disaster recovery trigger, including an application identifier; retrieve the one or more tasks from the disaster recovery file including the application identifier; validate at least the retrieved one or more tasks and inputs; and migrate the application components including the application identifier from the primary region to the secondary region in response to execution of the validated one or more tasks.

Some embodiments are directed to a method including receiving a disaster recovery trigger, including an application identifier; retrieving one or more tasks from a disaster recovery file including the application identifier, wherein the disaster recovery file is a YAML file; validating at least the retrieved one or more tasks and inputs; and migrating the application components including the application identifier from the primary region to the secondary region in response to execution of the validated one or more tasks.

In some embodiments, a communication device associated with a back-end application computer server exchanges information with remote devices in connection with an interactive graphical interface. The information may be exchanged, for example, via public and/or proprietary communication networks.

A technical effect of some embodiments of the invention is an improved and computerized way to accurately and automatically initiate and execute (e.g., orchestrate) a disaster recovery plan in a way that provides fast and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block diagram of a disaster recovery plan in accordance with some embodiments.

FIG. 2 is a high-level block diagram of a Disaster Recovery Orchestration as Code (DROaC) framework in accordance with some embodiments.

FIG. 3 illustrates a method in accordance with some embodiments.

FIG. 4 illustrates a YAML file in accordance with some embodiments.

FIG. 5 illustrates a user interface in accordance with some embodiments.

FIG. 6 illustrates a method in accordance with some embodiments.

FIG. 7 is a block diagram of an apparatus or platform in accordance with some embodiments.

FIG. 8 is a portion of a data store in accordance with some embodiments.

FIG. 9 illustrates a tablet computer display in accordance with some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

The present invention provides significant technical improvements to facilitate data efficiency and usefulness associated with disaster recovery for application component migration during a disaster. The present invention is directed to more than merely a computer implementation of a routine or conventional activity previously known in the industry as it provides a specific advancement in the area of electronic record analysis by providing improvements in the operation of a computer system that facilitates the orchestration of the execution of a disaster recovery plan. The present invention provides improvement beyond a mere generic computer implementation as it involves the novel ordered combination of system elements and processes to provide improvements in the speed and ease of recovery time to normal IT infrastructure, software and systems operations after a disaster. Some embodiments of the present invention are directed to a system adapted to automatically execute one or more tasks in a disaster recovery plan. Some embodiments of the present invention are directed to aggregate data from multiple data sources, to automatically optimize equipment information to reduce unnecessary messages or communications, etc. Moreover, communication links and messages may be automatically established, aggregated, formatted, exchanged, etc. to improve network performance (e.g., by reducing an amount of used network messaging bandwidth and/or storage required to implement such data retrieval, support technological updates, etc.). For example, embodiments may reduce an amount of used network messaging bandwidth because once the plan is initiated, each task is automatically executed, as compared to conventional systems where a user sends a message to initiate a task, then receives a message when that task is completed, and sends another message to initiate the next task, etc. As another example, embodiments may reduce an amount of storage used by providing for the re-use of DR automations and disaster recovery files (YAML files) between different Line of Businesses (LOB)s and teams, unlike conventional systems where the DR automations were LOB-specific and were saved for each application for each LOB; and disaster recovery files, as described herein, did not exist.

As described above, Disaster Recovery (DR) is an enterprise's method (e.g., policies, tools and processes) to regain or continue operations of information technology (IT) infrastructure, software and systems after disaster events like a natural disaster (e.g., earthquake, flood, etc.), human-made disaster (e.g., cyber-attack), pandemics, technical hazards (e.g., power outages, etc.), machine and hardware failure or any other type of enterprise disruption. A disaster is any event that disrupts or completely stops an enterprise from operating. One method for DR involves a multi-region strategy. With a multi-region strategy, data flows (e.g., workloads) operate in a primary region and a secondary region with full capacity. The main data flows through the primary region, and the secondary region acts as a recovery region in case of a disaster. In case of a disaster, the data flow through the primary region is migrated to the secondary region.

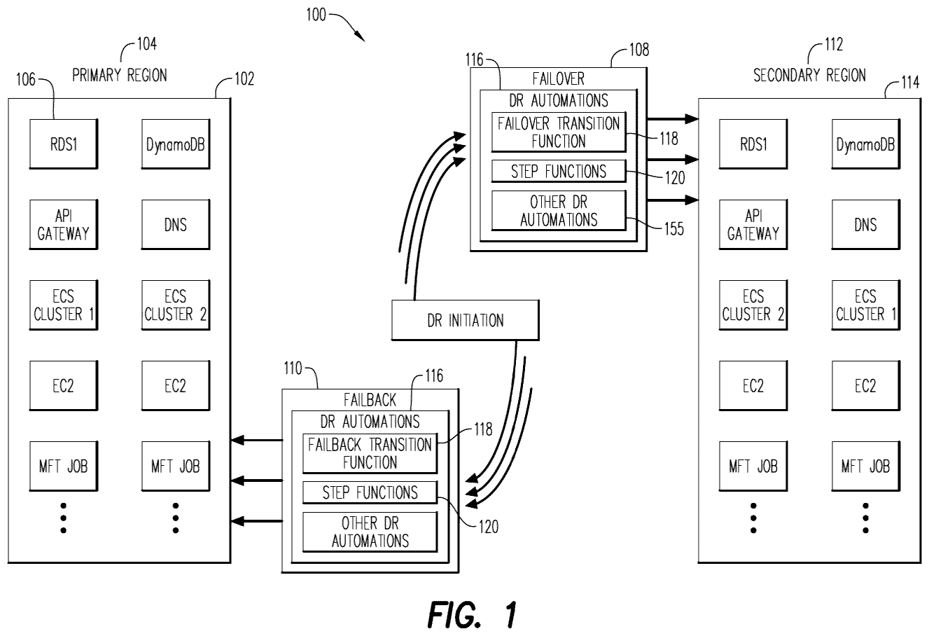

Consider the non-exhaustive example of FIG. 1. The system 100 includes an application 102 hosted in a primary region 104 of a cloud computing environment (e.g., AWS cloud®). The application 102 includes a plurality of components 106. The components 106 include, but are not limited to, a relational database service (RDS), a non-relational database service (e.g., DyamoDB®), an API Gateway, a Domain Name System (DNS) Service (e.g., Amazon's Route 53®), Container Clusters (e.g., Amazon's Elastic Container Service (ECS)), Networking components (e.g., Amazon's EC2®), managed file transfer (MFT) jobs, etc. In case of the disaster, the DR plan is triggered. The DR plan includes failover processes 108 and failback processes 110.

The failover processes 108 switch the data flow from the primary region 104 of the cloud to a backup (recovery) secondary region 112 of the cloud. The secondary region 112 copy of the application (secondary region application 114), in this case, is initialized during failover to replace the application in the primary region. Data on the copied system (e.g., secondary region) mirrors the data on the source system (e.g., primary region) at the instant of being copied. During the failover processes, data flows (e.g., workloads) are transferred to the secondary region, although some changes may occur as operations continue. In some instances, any changes during a failure event are written to virtual storage associated with the secondary region.

The failback processes 110 returns the flow to the original (or new) primary region 104 after a disaster (or scheduled event) is resolved. During the failback processes, data flow (e.g., workloads) returns from the secondary region to the primary region, and only the interim (altered) update data from the secondary region transfers to the primary region. The new/restored system at the primary region and the recovery system of the secondary region may then be synchronized to account for any incremental changes that occur at the secondary region following the failover.

Both the failover processes 108 and the failback processes 110 include certain steps for transferring the data flow from one region to another. The steps may be executed in a specific sequence, and there may be dependencies between the steps. To further simplify the example in FIG. 1, consider three application components 106—a front-end application component (e.g., a website), an API component and a database component—that are crucial components for most applications. In order to ensure the application is up and running in the secondary region 112, first the data flow for the database component is migrated to the secondary region 112, then the data flow for the API component is migrated and last, the data flow for the front-end application component is migrated. The migration (e.g., transfer) of the data flows for these components may be via a DR automation 116. A DR automation 116 is software code and/or scripts that automatically execute the steps to transfer the data flow. An example of a DR automation is a failover transition function, which may be referred to as a “failover lambda” 118. A “failover lambda” refers to a Lambda function specifically designed to handle failover scenarios within an application, meaning it automatically activates and takes over critical operations when the primary region experiences a disaster, allowing for seamless continuation of functionality by transferring the functionality to the secondary region. Non-exhaustive examples of lambda functions are: updating DNS records to point to a secondary region of the cloud, switching database connections to a standby instance, redirecting to a different API endpoint, etc. A group of Lambda functions may be referred to as “step functions” 120. Other DR automations 155 (e.g., non-failover transition functions and non-step functions) may also be included as DR automations. Not all DR automations are implemented as transition functions (lambda) or step functions, and these other DR automations 155 may be implemented by other scripts. As a non-exhaustive example, Ansible playbook® may be an other DR automation 155. Ansible playbook® is an organized unit of scripts that defines the tasks involved in managing a system configuration using the automation tool Ansible® from Red Hat®.

It is also noted that while a DR plan may have an automation for each component, there are instances where an automation does not exist. Even if the DR plan for each component within the application is automated (e.g., there is an automation for each component), orchestration of each of these automations is not available. Due to the lack of automatic orchestration, a conventional user manually triggers the particular automations to move the functionality of the specific individual components from the primary region on the cloud to the secondary region on the cloud. The manual transfer of the data flow may be on a component-by-component basis. As described above, to successfully execute the DR plan, the migration of components is executed in a specific sequential order to at least ensure the dependencies are met. There are often a varied number of steps based on the application that need to be triggered manually in a specific order per certain dependencies on prior steps. Based on the number of steps, a user may spend hours triggering each step and any following steps, which may impact application RTO. Further the conventional manual process results in exposure to human error as the steps are being performed for both failback and failover processes.

The automations are conventionally manually executed by the user via a web application (e.g., AWS Console®). However, during a disaster, the web application may not be available, preventing the DR plan from being executed.

Another challenge with the conventional manual execution of the automations is that there are no authorization checks for a DR cutover. A DR cutover refers to the process of switching to a DR system (e.g., from the primary region of the cloud to the secondary region of the cloud) in the event of a critical system failure (e.g., disaster).

To address these problems, the Disaster Recovery Orchestration as Code (DROaC) framework provided by embodiments automatically and dynamically executes the steps for transferring the data flow from the primary region of the cloud to the secondary region of the cloud based on tasks in a user-defined Disaster Recovery (DR) file. Pursuant to embodiments, once the DR process is initiated, there is no human interaction, and the data flows for the components are transferred based on the tasks written in the DR file. The DROaC framework applies in both cases where there is an actual disaster event and in cases in which the disaster recovery plan is being tested. It is noted that testing DR plans is important to make sure they work during an actual disaster event. Embodiments provide “single-click” trigger capability to orchestrate all the DR automations, reducing time and effort for DR tests and recovery during real disaster events. In one or more embodiments, authorization and validation processes precede execution of the DR automations. One or more embodiments also provide for the re-use of existing DR automations by lines of business (LOB)s that did not create the DR automation, reducing storage requirements.

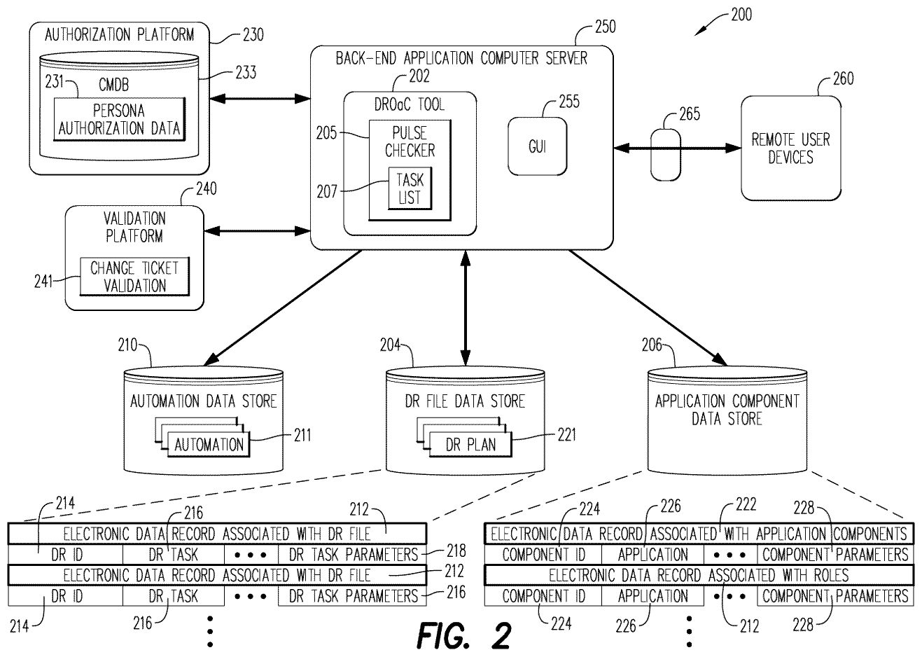

FIG. 2 is a high-level block diagram of a DROaC framework or system 200 according to some embodiments of the present invention. In particular, the system 200 includes a back-end application computer server 250 and a DROaC tool 202 that may access information in DR file data store 204, application component data store 206 and automation data store 210. The DR file data store 204 stores DR plans 221 and a set of electronic records representing DR files 212 (i.e., a YAML file), and including a disaster recovery identifier 214, one or more disaster recovery tasks 216 for each application and other disaster recovery task parameters 218. The application component data store 206 stores a set of electronic records associated with an application component 222, and including for each application component, at least a component identifier 224, an application 226, and component parameters 228 (e.g., a primary (first) region and a secondary (second) region). The automation data store 210 stores automations 211. The DROaC tool 202 may also retrieve information from other data stores or sources (e.g., persona authorization data 231 from an authorization platform 230, and change ticket validation data 241 from a validation platform 240) in connection with a Graphical User Interface (“GUI”) to view, analyze and/or update the electronic records.

The back-end application computer server 250 may also exchange information with other data stores and utilize a Graphical User Interface (“GUI”') 255 to view, analyze, and/or update the electronic records. The back-end application computer server 250 may also exchange information with a remote user device 260 (e.g., via a firewall 265). In some embodiments, the remote user device 260 may transmit annotated and/or updated information to the back-end application computer server 250. Based on the updated information, the back-end application computer server 250 may adjust data in the data store 204/206/210, and/or the change may be viewable via other remote user devices. Note that the back-end application computer server 250 and/or any of the other devices and methods described herein might be associated with a cloud-based environment and/or a third party, such as a vendor that performs a service for an enterprise.

Presentation of a user interface via the GUI 255 may include any degree or type of rendering, depending on the type of user interface code generated by the back-end application computer server 250. For example, a user (not shown) may execute a Web Browser to request and receive a Web page (e.g., in HTML format) from back-end application computer server 250 via HTTP, HTTPS, and/or WebSocket, and may render and present the Web page according to known protocols.

The DROaC tool 202 receives a trigger for initiating execution of the DR Plan 221, including a DR file, for a given application. The trigger may be manual or automatic, as described further below. The DROaC tool 202 then determines, with input from the authorization platform 230 and the validation platform 240 whether the source of the trigger is authorized to initiate execution of the DR Plan 221, and validates the disaster recovery event type (scheduled DR test or actual DR event with incident), respectively. In a case the trigger source is authorized, and the disaster recovery event type is valid, the DROaC tool 202 then retrieves the disaster recovery (i.e., YAML (“YAML Ain't Markup Language”)) file for the given application. The DROaC tool 202 then derives the tasks as directed in the YAML file, validates the tasks, inputs and dependencies, and executes the tasks per order and dependency (if there is dependency). In a case the tasks are executed correctly, an output of the DROaC tool 202 is the migration of the data flow from each component in the primary region of the cloud to the secondary region of the cloud in a case of a fail over process, or the migration of the data flow from each component in the secondary region of the cloud to the primary region of the cloud in a case of a failback process. In a case of correct execution or incorrect execution (e.g., the data flow from less than all of the components is transferred between the primary region and the secondary region), the status of the DROaC output may be rendered and displayed on the GUI.

Data store 204/206/210 may be any query-responsive data source or sources that are or become known, including but not limited to a SQL relational database management system.

Data store 204/206/210 may include or otherwise be associated with a relational database, a multi-dimensional database, an Extensible Markup Language (XML) document, or any other data storage system that stores structured and/or unstructured data. The data of data store 204/206/210 may be distributed among several relational databases, dimensional databases, and/or other data sources. Embodiments are not limited to any number or types of data sources. A structured query language (SQL) script may be generated based on a request for data and forwarded to the data store 204/206/210. The data store 204/206/210 may execute the SQL script to return a result set based on data of the data store 204/206/210.

The back-end application computer server 250 may store information into and/or retrieve information from the data store 204/206/210. The data store 204/206/210 may be locally stored or reside remote from the back-end application computer server 250. As will be described further below, the data store 204/206/210 may be used by the back-end application computer server 250 to access and update electronic records. Although a single back-end application computer server 250 is shown in FIG. 2, any number of such devices may be included. Moreover, various devices described herein might be combined according to embodiments of the present invention. For example, in some embodiments, the back-end application computer server 250 and data store 204/206/210 might be co-located and/or may comprise a single apparatus and/or be implemented via a cloud-based computing environment.

The back-end application computer server 250 may be separated from or closely integrated with the data store 204/206/210. A closely-integrated server 250 may enable execution of services completely on the database platform, without the need for an additional server. For example, back-end application computer server 250 may provide a comprehensive set of embedded services which provide end-to-end support for Web-based applications. The services may include a lightweight web server, configurable support for Open Data Protocol, server-side JavaScript execution and access to SQL and SQLScript. The back-end application computer server 250 may provide application services (e.g., via functional libraries) using services that manage and query the database files stored in the data store 204/206/210. The application services can be used to expose the database data model, with its tables, views and database procedures, to clients. In addition to exposing the data model, the back-end application computer server 250 may host system services such as a search service, and the like.

The back-end application computer server 250 and/or the other elements of the system 200 might be, for example, associated with a Personal Computer (“PC”), laptop computer, tablet, smartphone, an enterprise server, a server farm, and/or a database or similar storage devices.

According to some embodiments, an “automated” back-end application computer server 250 (and/or other elements of the system 200) may facilitate the automated access and/or update of electronic records. As used herein, the term “automated” may refer to, for example, actions that can be performed with little (or no) intervention by a human.

As used herein, devices, including those associated with the back-end application computer server 250 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

Note that the system 200 of FIG. 2 is provided only as an example, and embodiments may be associated with additional elements or components. According to some embodiments, the elements of the system 200 automatically transmit information associated with an interactive user interface display over a distributed communication network.

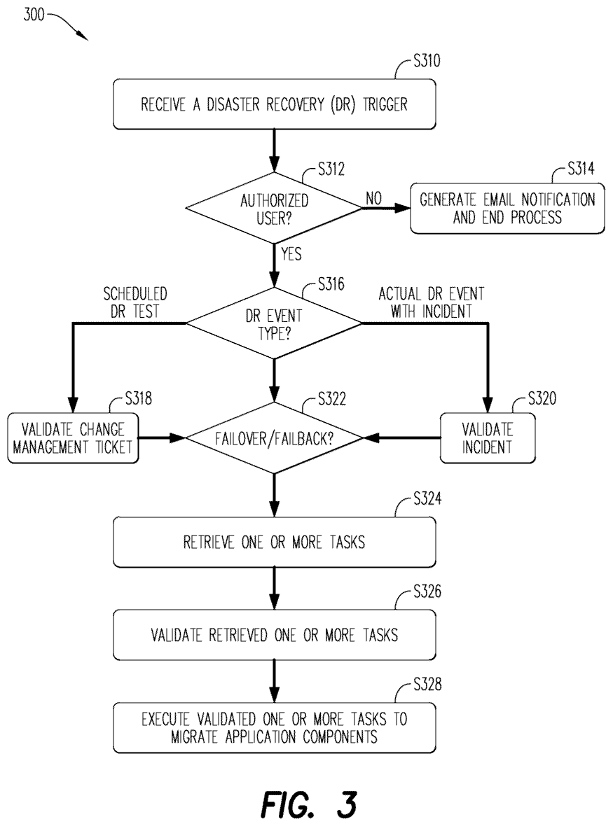

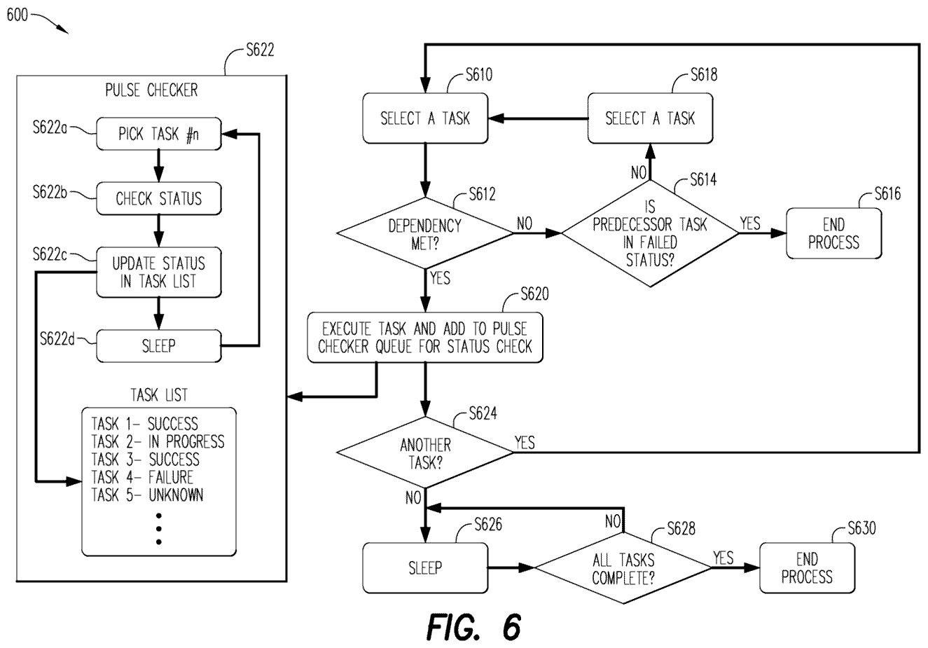

FIGS. 3 and 6 illustrate a process 300/600 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

FIG. 3 comprises a flow diagram of a process 300 to execute a DR plan according to some embodiments. Process 300 and other processes described herein (e.g., 600) may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

Prior to the process 300, a disaster recovery file is generated and stored in the DR file data store 204. The disaster recovery file is a YAML file. YAML is a human-readable data serialization language used to write configuration files and used in applications where data is being stored or transmitted. The primary function of YAML is data transmission, and it uses white spaces (e.g., indentations (as opposed to tabs in XML)) to define a hierarchical structure. YAML is often for data, not documents. YAML uses key-value pairs to store data. Pursuant to embodiments, the YAML file is a text file that includes an outline of the DR plan including the tasks for a failover/failback process for the given application. The YAML file is created by an application team and/or a line of business (LOB) reliability engineering (RE) squad.

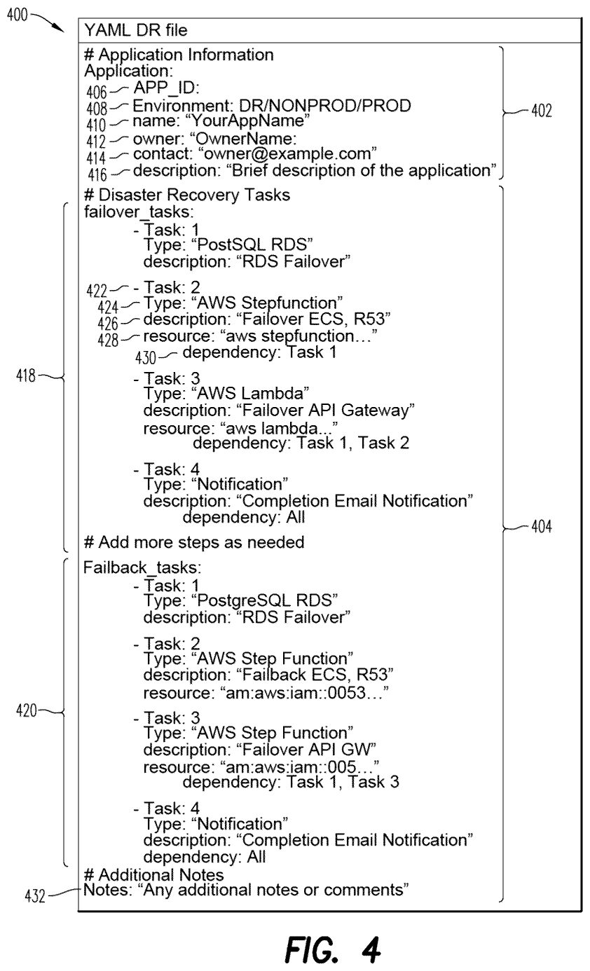

FIG. 4 includes a non-exhaustive example of a YAML file 400. The YAML file 400 includes a header section 402 including details about the application being migrated and a task section 404 including the tasks for data flow transfer. The header section 402 includes an application ID 406, an environment 408 (e.g., DR/Non-Production/Production), an application name 410, an application owner 412, contact address 414, and a description of the application 416. In one or more embodiments, the header section 402 may also include a primary region description and secondary region description. The primary region and the secondary region may be US locations or international locations (e.g., Europe). In some embodiments, the primary region and secondary region may default based on the line of business (LOB) using the application and where the application is being used and/or where LOB is located. The task section 404 includes a failover task sub-section 418 and a failback task sub-section 420. Each of the failover task sub-section 418 and the failback task sub-section 420 includes one or more tasks 422 for data flow transfer. The tasks 422 are listed in the YAML file 400 in the sequential order in which they should be executed. Each task 422 includes the following keys: task type 424, a task description 426, and a task resource 428 (e.g., the location from which the task is executed). Each task corresponds to an automation 211, stored in an automation data store 210, per the orchestration capability of the DROaC tool 202. The YAML file has a standard set of types for the task. The standard task types are approved by architecture administrators. The task type approval process provides for only certain types of tasks to be executed by the application during execution of the DR plan. Non-exhaustive examples of tasks are: Postgre RDS Failover via Red Hat's Ansible Playbook®, AWS CLI execution, Ansible Playbook execution, Generating API calls (MFT), Executing Jenkins+Terraform pipelines, Executing AWS code pipelines, and email notifications. Pursuant to embodiments, new types may be introduced and approved by the architecture administrators or other suitable parties. As a non-exhaustive example, a DR automation 211 is created for DynamoDB for a given application per a Global Specialty team, and a new type is created in the YAML (e.g., “AWS DynamoDB” after approval by the suitable party. Other teams (e.g., Group Benefits) may be made aware of this new DR automation 211 so they can reference it in their YAML files as well. The Group Benefits team may see the AWS DynamoDB component already has a corresponding DR automation 211, and may then call that type within their own YAML file. Then, when executed the DROaC tool 202 will be able to pick up that same automation 211 that was brought in by the Global Specialty team and use it for Group Benefits. In this way, Global Specialty engaged in a “Bring your own GitHub DR automation/action” and Group Benefits was able to use that DR automation 211 from a DR automation store/repository 210. There may be multiple DR automations associated with a unique type of task, and these DR automations 211 may be stored in a repository 210 such that they are accessible to users besides the one that created them.

In some instances, the task 422 also includes any dependencies 430. As indicated by the indentation, dependency is part of the hierarchical structure. In the case the dependency is listed, the task 422 cannot begin until the task on which it depends is completed. The DROaC tool 202 includes a polling mechanism (e.g., pulse checker 205) for the tasks which are running asynchronously (e.g., step functions, pipelines, etc.). The pulse checker 205 provides for the DROaC tool to know which task dependencies are met and which tasks are to be triggered as successors of the ones which are completed. The implementation of task execution is described further below. The user may write as many tasks for as many steps as are needed to transfer the application to another region.

In the non-exhaustive example YAML file 400 shown herein, Task 1 in the failover tasks sub-section 418 has the task type 424 of “PostgreSQL RDS”, and the task description 426 of “RDS Failover”. Task 2 is to execute a certain step function (type) and per the description, will failover ECS and R53. Task 2 in the failover tasks sub-section 418 has the task type 424 of “AWS Stepfunction”, the task description 426 of “Failover ECS, R53”, the task resource 428 of “aws stepfunction . . . ” and the dependency 430 of Task 2 on Task 1, such that when Task 1 completes, Task 2 may be executed. Task 3 in the failover tasks sub-section 418 has the task type 424 of “AWS Lambda”, the task description 426 of “Failover API Gateway” and the task resource 428 is “aws lambda . . . ”. Task 3 is dependent on both Task 1 and Task 2 completing, as indicated by the dependency 430 key. The YAML file 400 may also include any additional notes or comments 432. It is also noted that the YAML file 400 may be edited to include additional and/or different tasks. In this way an authorized user may change the YAML to suit their needs. As a non-exhaustive example, consider a first group (e.g., Group Benefits) creates the YAML file and a second group (e.g., Global Specialty) has the same application with an additional component, the second group (Global Specialty) can use the YAML file of the first group (Group Benefits) and add the additional component, without having to re-create the YAML file. Each version of the YAML file is saved in the data store 204.

Also prior to process 300, after the YAML file 400 is created, an application workflow is created. As a non-exhaustive example, the application workflow is an Application GitHub Action (GHA) Workflow®. Pursuant to some embodiments, the YAML file 400 is uploaded to a GitHub repository, and the YAML file in the GitHub repository is enabled with GitHub actions. An action in GitHub is a custom application that performs a complex but repetitive task in a workflow. The application workflow analyzes the YAML file to ensure the YAML file is formatted correctly.

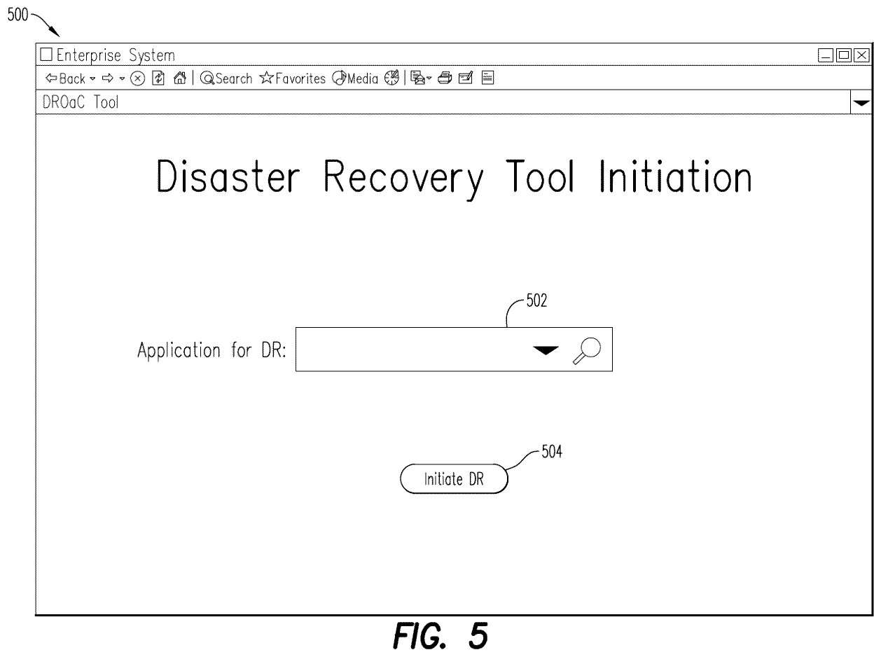

Initially, at S310 a disaster recovery (DR) trigger is received. The DR trigger may at least include the application id for the application affected by the disaster event. In one or more embodiments, the DR trigger may also include at least one of an environment, a ticket number, a DROaC file path, and a failover/failback indication. The DR trigger may be received manually, via user selection on a DR user interface (UI) 500 as shown in FIG. 5. The user has logged-in to the DROaC tool and then the DR initiation UI 500 may be displayed. The DR user interface 500 includes an application for DR element 502. The application for DR element 502 may be a data entry field, as shown herein, or may be a drop-down menu, a static menu, or other suitable element. After selection of the application via the application for DR element 502, the “initiate DR” control 504 is selected. Selection of the “initiate DR” control 504 is the trigger. Selection of the “initiate DR” control is a “single-click” trigger capability provided by embodiments to orchestrate all of the DR task automation 211, reducing time and effort involved for DR tests and recovery during real DR events. The DR trigger may also be received as: a scheduled DR trigger, an API trigger, and a Jenkins Trigger. The scheduled DR trigger refers to a trigger scheduled such that the process 300 automatically executes per that schedule (e.g., every week, month, 6-months, etc.). The Application Programming Interface (API) trigger refers to a mechanism whereby a specific API call acts as a signal to initiate the process 300, automating the process when a disaster event occurs by sending a command through the API. A monitoring system may be set up to detect the disaster event and then initiate the API call to trigger the process 300. The Jenkins trigger refers to a pre-configured automated mechanism within the Jenkins Continuous Integration (CI)/ Continuous Deployment (CD) platform that initiates the process 300. The Jenkins trigger may be set up to activate based on specific events, such as alerts from monitoring systems, network failures, or database unavailability, signaling the need to initiate recovery actions.

It is noted that the following S312 to S328 are part of a centralized DROaC workflow (“DROaC workflow) that is initiated by the application workflow. Pursuant to some embodiments, the centralized DROaC workflow includes, in part, one or more GitHub Actions (GHA) (e.g., custom applications). It is further noted that while embodiments are described with respect to an AWS account running GitHub Action Runners (e.g., an application that executes jobs (e.g., actions) from a GitHub Actions workflow), and applications running on the AWS account, the workflows and processes described herein may be executed on other suitable platforms.

After receipt of the trigger, it is determined at S312 whether an authorized user has initiated the DR trigger. Pursuant to embodiments, only certain roles within the enterprise are authorized to trigger the DR process 300. In the case of the manual DR trigger, the DROaC tool 202 sends an API call to the authorization platform 230, which analyzes the persona authorization data 231 in a configuration management database (CMDB) 233 to determine whether the user initiating the manual trigger is authorized to do so. The API call may be a service now (SNOW) custom API. In the case of an automated trigger (e.g., scheduled trigger, API trigger, and Jenkins trigger), the DROaC tool 202 confirms the source of these triggers via API calls to the appropriate platform. For example, in the case of a scheduled trigger, the DROaC tool 202 may confirm this is the appropriate time to initiate the process per the schedule. It is noted that the automated triggers are the “other DR automations” 155 described with respect to FIG. 1. The DROaC tool 202 executes these other DR automations as well, however, they are distinct from the automations 211 executed per the YAML file 400.

In a case the user initiating the DR trigger is not authorized, the process proceeds to S314 and an email notification is sent to the application owner (or other suitable party) indicating an unauthorized attempt at initiating the DR process, and the process 300 ends.

In a case the user initiating the DR trigger is authorized, the process proceeds to S316 and a DR event type is determined. The DR event type is one of a scheduled DR test and an actual DR event with an incident. The DROaC tool 202 may determine whether there is a scheduled DR test, and if not, the event is an actual DR event. In the case of a scheduled DR test, the process 300 proceeds to S318 and a change management ticket is validated. The DROaC tool 202 sends an API call to the validation platform 240, which confirms validation via change ticket validation data 241. The API call may be a service now (SNOW) custom API. The change ticket validation data 241 makes sure the process 300 is only executed for particular change ticket numbers or change ticket incidents, such that the process is not triggered without one of these valid reasons. In the case of an actual DR event, the process 300 proceeds to S320 and the incident is validated via suitable API calls.

Following both S318 and S320, the process 300 proceeds to S322, and it is determined whether the failover tasks or the failback tasks in the YAML file 400 are to be retrieved. As described above, if operations (data flow) are transferring from the primary region to the secondary region, it's a failover event; if the operations (data flow) are returning from the secondary region to the primary region, it's a failback event. Pursuant to some embodiments, the DROaC tool 202 identifies the current location of the data flow to determine whether to retrieve the failover tasks or the failback tasks. In a case the data is currently at the primary region, the failover tasks are retrieved; in a case the data is currently at the secondary region, the failback tasks are retrieved. In other embodiments, the failover/failback indication is included with the DR trigger.

Then in S324 and based on the determination, the YAML file corresponding to the application is retrieved from the DR file data store 204, and one of the failover tasks or the failback tasks are retrieved from the YAML file. The DROaC tool 202 identifies the YAML file based on the application identifier included in the received DR trigger, and corresponding application identifier 406 in the YAML file.

Next, in S326, the one or more retrieved tasks are each validated. Validation of the retrieved tasks includes, but is not limited to, identifying dependencies for each task, ensuring the dependencies are not infinite, identifying inputs for each task, whether the inputs have been received, and if the inputs have not been received, how to obtain the inputs. With respect to the infinite dependencies, a non-exhaustive example is Task 2 is dependent on Task 3 and Task 3 is dependent on Task 2.

After the one or more retrieved tasks are each validated, the validated tasks are executed in S328, whereby execution of the tasks migrates the data flow for the application components from one region to another per the sequentially ordered tasks and dependencies. Migration of the data flow may be referred to herein as “migration of the components”. In this step, both the particular automations 211 corresponding to the validated tasks and the other DR automations 155 are executed. Pursuant to embodiments, for execution of the automations 211 corresponding to the validated tasks, the DROaC tool 202 parses the YAML file and extracts the type for each task, and any key-value pairs associated with the type for that particular task. Based on the extracted task type and key-value pairs, the DROaC tool 202 identifies the corresponding automation 211 for that task (e.g., based on task type), and the automation 211 for that task is executed at the appropriate time (e.g., the process reached that task in the sequence in the YAML file, and after dependencies are met). As described above, the automations 211 may be represented by actions in Github, where a Github Action (GHA) is a custom application/code that in this case is specified for a specific task type. As a non-exhaustive example, if there are twenty different task types, then there will be twenty different GHAs for those respective task types. The GHA includes a metadata file to define the inputs, outputs and main entry points for the action. As a non-exhaustive example, a GHA will pick up the RDS connection detail (e.g., pick up the database name/id, which AWS account it is associated with, etc.) and execute the DR process for that task. For example, in a case of a failover, the GHA will determine whether the secondary region has a database cluster available, and if there is an available database cluster, the GHA will create an instance of the RDS database on top of the secondary region cluster. The creation of the instance of the RDS database on top of the secondary region cluster transitions the data flow from the primary region to the secondary region. Once the GHA has completed execution of the task, the GHA will output a status indicating the task is complete. In a case the task cannot be completed, the GHA will output a status indicating the task is incomplete. The task may not be completed for reasons including, but not limited to, the process was not completed in a pre-set amount of time, inputs were corrupt, other system failure, etc.

As described above, while there may be a separate automation 211 (GHA) for each task/component, execution of the different automations may be via the particular DROaC workflow. The orchestration of the execution step S328 of the DROaC workflow is described further below with respect to FIG. 6.

Turning to FIG. 6, a flow diagram of a process 600 to orchestrate and execute the automations 211 is provided according to some embodiments.

Initially, at S610, a validated task (e.g., task #n) is selected.

In S612 it is determined whether the dependencies for the selected task have been met (e.g., successfully executed). The determination is based on a task status in a task list of a pulse checker 205. In a case the dependency is not met (e.g., the predecessor task on which the current task depends does not have a success status), the process proceeds to S614 and it is determined whether the predecessor has a failed status. The predecessor task status may be determined via analysis of a task list 207. In a case the predecessor task has a failed status, the process ends at S616. In a case the predecessor task does not have a failed status (e.g., the predecessor task has one of an “in progress” status or an “unknown status”), the process 600 proceeds to S618 and the process sleeps for a predetermined amount of time (e.g., one minute), and then returns to S610, and the task may again be selected to check whether the dependency is met.

Turning back to S612, in a case the dependency is met, the process 600 proceeds to S620. At S620 the task is executed via the automation 211 and the task is added to the pulse checker queue for a status check. The status check is executed by the pulse checker 205 at S622. In particular, the task is logged in a pulse checker 205, as the task is executed. The pulse checker 205 polls for the status (success/failure) of each asynchronous task. The status (success/failure) indicates whether the process 600 may move on to selecting the next task in the sequence. The process may not move on to selecting the next task in a case the dependency has met: one or more predecessors that have failed, or one or more predecessors are still in progress. The pulse checker 205 first picks task “n” at S622a, then at S622b, the status for task “n” is checked. The updated status (e.g., success, in progress, failure, unknown) is added to the task list 207 in S622c. In S622d, the pulse checker sleeps for a predetermined amount of time (e.g., one minute), and then returns to S622a to one of: re-check the status for task “n” or check the next task in the sequence.

After execution of the task at S620, the process proceeds to S624 and it is determined whether there is another task in the sequence. The DROaC tool 202 may parse the YAML file to determine whether there is another task in the sequence.

In a case it is determined at S624 there is another task, the process returns to S610 and the next task is selected.

In a case it is determined at S624 there is not another task, the process proceeds to S626 and the process sleeps for a predetermined amount of time (e.g., one minute) waiting for the tasks to complete and then proceeds to S628. At S628 it is determined whether all of the tasks are complete. The determination is based on the status of the tasks in the task list 207. In a case it is determined at S628 all of the tasks are not complete, the process returns to S626 and the process sleeps. In a case it is determined at S628 that all of the tasks are complete, the process ends at S630.

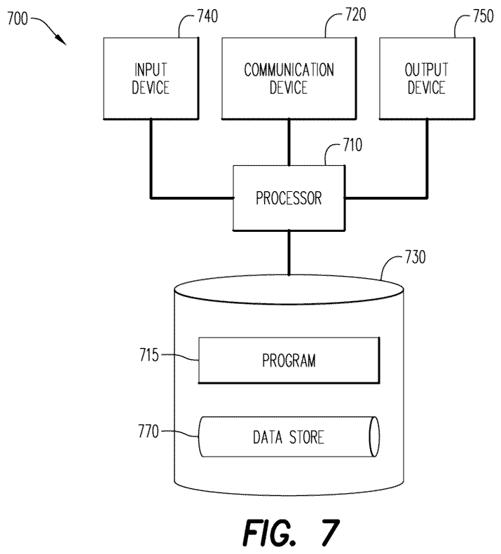

The embodiments described herein may be implemented using any number of different hardware configurations. For example, FIG. 7 illustrates an apparatus 700 that may be, for example, associated with system 200 described with respect to FIG. 2. The apparatus 700 comprises a processor 710, such as one or more commercially available Central Processing Units (“CPUs”) in the form of one-chip microprocessors, coupled to a communication device 720 configured to communicate via a communication network (not shown in FIG. 7). The communication device 720 may be used to communicate, for example, with one or more remote third-party business or economic platforms, administrator computers, insurance agents, and/or communication devices (e.g., PCs and smartphones). Note that communications exchanged via the communication device 720 may utilize security features, such as those between a public internet user and an internal network of an insurance company and/or enterprise. The security features might be associated with, for example, web servers, firewalls, and/or PCI infrastructure. The apparatus 700 further includes an input device 740 (e.g., a mouse and/or keyboard to enter information about data sources, application components, DR plans, etc.) and an output device 750 (e.g., to output YAML files, status of execution of DR plans, etc.).

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 715 and/or an application for controlling the processor 710. The processor 710 performs instructions of the program 715, and thereby operates in accordance with any of the embodiments described herein. For example, the processor 710 may receive a request for initiation of a DR plan, and based on the system tools, automatically transfers the data flow of an application from a primary region to a secondary region or vice versa and outputs the status of the data flow transfer.

The program 715 may be stored in a compressed, uncompiled and/or encrypted format. The program 715 may furthermore include other program elements, such as an operating system, a database management system, and/or device drivers used by the processor 710 to interface with peripheral devices.

As used herein, information may be “received” by or “transmitted” to, for example: (i) the apparatus 700 from another device; or (ii) a software application or module within the apparatus 700 from another software application, module, or any other source.

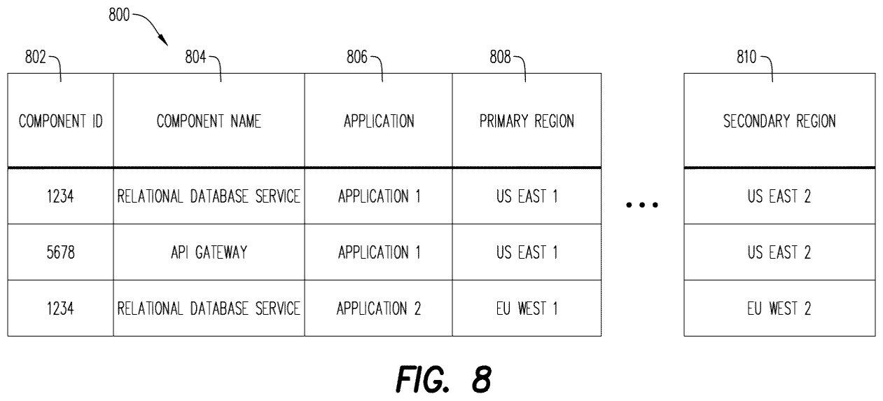

In some embodiments (such as shown in FIG. 7), the storage device 730 further includes a data store 770. An example of a database that might be used in connection with the apparatus 700 will now be described in detail with respect to FIG. 8. Note that the database described herein is only an example, and additional and/or different information may be stored therein.

Moreover, various databases might be split or combined in accordance with any of the embodiments described herein. For example, the data store 770 might be combined and/or linked with another data store within the program 715.

Referring to FIG. 8, a table is shown that represents the data store 800 that may be stored at the apparatus 700 according to some embodiments. The table may include, for example, entries related to components for applications hosted in a cloud computing environment. The table may also define fields 802, 804, 806, 808, 810 for each of the entries. The fields, 802, 804, 806, 808, 810 may, according to some embodiments, specify: a component identifier 802, a component name 804, application 806, primary region 808 and secondary region 810. The data store 800 may be created and updated, for example, based on information electrically received from various data sources (e.g., including when a new component is added to an application in a cloud computing environment) that are associated with an enterprise such as an insurance provider.

The component identifier 802 may be, for example, a unique alphanumeric code associated with the component for an application hosted by a cloud-computing environment. The component name 804 may indicate the name of the component included in the application. The application 806 may indicate the name of the application to which the component is included. The primary region 808 may indicate the main location for the data flow for that component and application. The secondary region 810 may indicate the backup location for the data flow for that component and application.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

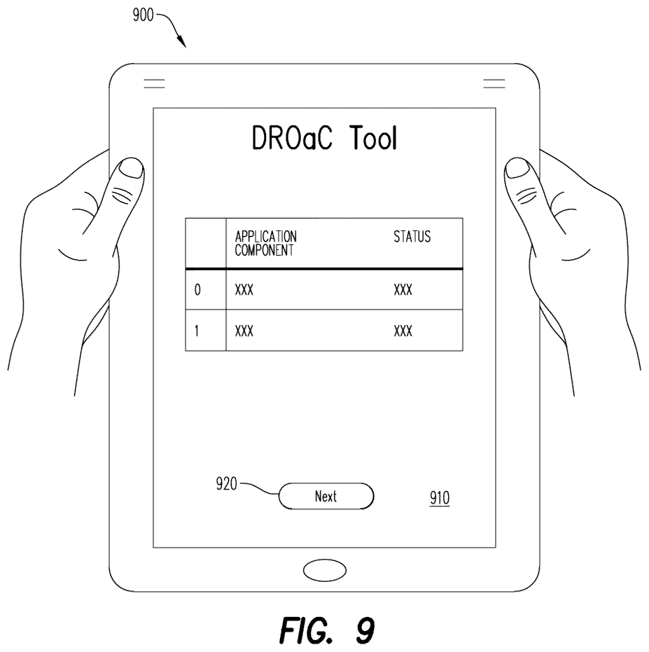

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of entities, embodiments may instead be associated with other types of businesses in addition to and/or instead of those described herein (e.g., financial institutions, universities, governmental departments, any enterprise migrating a lot of data). Similarly, although certain types of certain attributes were described in connection with some embodiments herein, other types of attributes may be used instead. Still further, the displays and devices illustrated herein are only provided as examples, and embodiments may be associated with any other types of user interfaces. For example, FIG. 9 illustrates a tablet computer 900 with an Application Component status display 910 according to some embodiments. The display 910 includes a table listing a component and its status in the failover/failback process. Selection of the “Next” icon 920 might result in transmission of a request for additional data regarding the failover/failback process (e.g., the number of tasks remaining in the failover/failback process, the expected time remaining until completion of the failover/failback process), etc.

The present invention has been described in terms of several embodiments solely for the purpose of illustration. Persons skilled in the art will recognize from this description that the invention is not limited to the embodiments described but may be practiced with modifications and alterations limited only by the spirit and score of the appended claims.

1. A disaster recovery system implemented via a back-end application computer server, comprising:
an application component data store that contains electronic records, each electronic record representing an application component and including for each application component: a component identifier, an application identifier identifying an application including the application component, a primary region, and a secondary region;
a disaster recovery file data store that contains electronic records, each electronic record representing a disaster recovery file and including the application identifier for each application component and one or more tasks for migrating each application component;
the back-end application computer server, coupled to the application component data store and the disaster recovery file data store, including:
a computer processor; and
a computer memory, coupled to the computer processor, storing instructions that, when executed by the computer processor, cause the back-end application computer server to:
receive a disaster recovery trigger, including the application identifier for each application affected by a disaster event;
retrieve the one or more tasks from the disaster recovery file including the application identifier for each application affected by the disaster event;
validate at least the retrieved one or more tasks, validation including identifying a dependency for at least one task and determining the identified dependency is not infinite, and identifying inputs for each task; and
migrate each application component including the application identifier for each application affected by the disaster event, the migration from the primary region for each component to the secondary region for each component in response to execution of the validated one or more tasks.

2. The system of claim 1, wherein a given application component is migrated per task.

3. The system of claim 1, wherein the disaster recovery file is a YAML file format.

4. The system of claim 3, wherein the tasks included in the disaster recovery file are recorded in the file in sequential execution order.

5. The system of claim 1, further comprising instructions that, when executed by the computer processor, cause the back-end application computer server to:
determine an authorization status of the disaster recovery trigger.

6. The system of claim 1, further comprising instructions that, when executed by the computer processor, cause the back-end application computer server to:
identify a disaster recovery event type for the received disaster recovery trigger.

7. The system of claim 6, wherein the disaster recovery event type is one of a scheduled disaster recovery test and an actual disaster recovery event.

8. The system of claim 1, wherein the disaster recovery file includes at least one dependency between two tasks.

9. The system of claim 8, wherein each dependency of the at least one dependency is validated in a case the retrieved one or more tasks and identified inputs for each task are validated.

10. The system of claim 1, further comprising for each task, a corresponding automation.

11. The system of claim 1, wherein prior to receipt of the disaster recovery trigger, each disaster recovery file is analyzed for correct formatting of the tasks.

12. A computer-implemented method comprising:
receiving a disaster recovery trigger, including an application identifier;
retrieving one or more tasks from a disaster recovery file including the application identifier, wherein the disaster recovery file is a YAML file and each task is for migrating an application component;
validating at least the retrieved one or more tasks, validation including identifying a dependency for at least one task and determining the identified dependency is not infinite, and identifying inputs for each task; and
migrating application components including the application identifier from a primary region to a secondary region in response to execution of the validated one or more tasks.

13. The method of claim 12, wherein the tasks included in the disaster recovery file are recorded in the file in sequential execution order.

14. The method of claim 12, further comprising:
determining an authorization status of the disaster recovery trigger; and
identifying a disaster recovery event type for the received disaster recovery trigger.

15. The method of claim 12, wherein the disaster recovery file includes at least one dependency between two steps.

16. The method of claim 12, further comprising for each disaster recovery task, a corresponding automation.

17. One or more non-transitory computer-readable media storing program code that, when executed by a computing system, causes the computing system to perform operations comprising:
receiving a disaster recovery trigger, including an application identifier;
retrieving one or more tasks from a disaster recovery file including the application identifier, wherein the disaster recovery file is a YAML file and each task is for migrating an application component;
validating at least the retrieved one or more tasks, validation including identifying a dependency for at least one task and determining the identified dependency is not infinite, and identifying inputs for each task; and
migrating application components including the application identifier from a primary region to a secondary region in response to execution of the validated one or more tasks.

18. The media of claim 17, wherein a given application component is migrated per task.

19. The media of claim 17, wherein the tasks included in the disaster recovery file are recorded in the file in sequential execution order.

20. The media of claim 17, further comprising:
determining an authorization status of the disaster recovery trigger; and
identifying a disaster recovery event type as one of a scheduled disaster recovery test and an actual disaster recovery event for the received disaster recovery trigger.
